(19) United States
(12) Patent Application Publication
(10) Pub. No.: US 2020/0016876 A1
(43) Pub. Date: Jan. 16, 2020

(54) INCREASING THE TEAR RESISTANCE OF A MULTI-LAYERED FILM

(71) Applicant: RKW SE, Frankenthal (DE)

(72) Inventors: Estelle Cheret, Kalmthout (BE); Luc Paepen, Oud-Turnhout (BE)

(73) Assignee: RKW SE, Frankenthal (DE)

(21) Appl. No.: 16/489,527

(22) PCT Filed: Mar. 21, 2018
(86) PCT No.: PCT/EP2018/057112

§ 371 Date: Aug. 28, 2019

(30) Foreign Application Priority Data
Apr. 3, 2017 (DE) 102017107060.5

(51) Int. Cl. B32B 27/08; B32B 27/32; B32B 27/34

(52) U.S. Cl. CPC B32B 27/08; B32B 27/327; B32B 27/34; B32B 2410/00; B32B 2307/582; B32B 2270/00; B32B 2307/7244

(57) ABSTRACT

The invention relates to a method of increasing the tear resistance of a multi-layered film. This multi-layered film includes at least one barrier arrangement that has a total thickness for reducing gas permeability. According to the invention, the barrier arrangement is divided into at least two layers, to increase tear resistance.

### TECHNICAL FIELD

The invention relates to a method for increasing the tear resistance of a multilayer film which has at least one barrier arrangement having a total thickness for reducing gas permeability.

### BACKGROUND

These kinds of multilayer films with barrier arrangements are employed in apparatuses for agricultural uses. One important use is exemplified by silage tubes. Film tube silaging is an efficient, flexible, and environmentally compatible technology for the preservation and storage of all kinds of fodder, in a film tube developed specifically for that purpose. While film tube silaging was developed originally for the ensilage of green material, nowadays a whole host of different materials can be stored in silage tubes. Silage tubes are also utilized for the composting of organic material. Today, for example, pressed chips and also corn and grass silages are also stored in silage tubes.

Filling the silage tubes requires specific machines, which in general first comminute the material to be ensiled and then press it into the tubes. One apparatus of this kind is described in DE 10 2010 046 183 A1.

Silage is a fodder product preserved by lactic acid fermentation for livestock, especially for ruminants. It is possible in principle for all green fodder to be silaged, including grass (grass silage), corn (corn silage), clover or else cereals (as complete whole-plant silage). Of critical importance to silaging is shielding against oxygen. Conventionally, stable, polyethylene-based films are used for silage tubes. The use of these conventional films, however, has been accompanied again and again by formation of mold, due to the penetration of oxygen.

Conventional polyolefin-based films, in order to ensure sufficient imperviousness toward oxygen, would have to be very thick and would consequently be heavy and relatively costly to produce.

Accordingly, films having specific barrier arrangements have been developed. These barrier arrangements comprise polymers which have particularly high impermeability toward gases, especially toward oxygen.

DE 698 17 012 T2 describes a multilayer film for agricultural silage products. The film has a layer of a polyamide that acts as oxygen barrier. The film product may be formed of two or more layers—of coextruded layers, for example—of which at least one layer or possibly even two or more layers are formed of an insulating plastics layer. In the case of a multilayer film having at least two insulating layers, these insulating layers may be formed of the same plastics material or of different plastics materials, all of which are airtight.

DE 10 2009 052 948 B4 describes a covering system for silages, having a polyamide underlay film and a polyethylene silage film.

The oxygen barrier arrangement is required to have a certain total thickness in order to sufficiently reduce the gas permeability. With conventional, prior-art films, the integration of an oxygen barrier arrangement having a certain total thickness leads to a deterioration in the mechanical properties of the film. This is a problem in particular with silage tubes, since these tubes are filled with comminuted fodder in a machine and, when the material is pressed into the silage tubes, the silage tubes may burst and/or tear.

### SUMMARY

It is an object of the invention to provide a method with which the tear resistance of films for agricultural use, more particularly of silage tubes or films for soil treatment, can be increased. The method is intended to adapt films having one or more oxygen barrier arrangements in such a way as to preserve sufficient protection against oxygen penetration and at the same time to improve the mechanical properties, more particularly the tear resistance. As a result, a film is to be provided for agricultural uses that has a high tear resistance in conjunction with low oxygen permeability and at the same time a relatively low thickness.

This object is achieved by a method and an apparatus having one or more features of the invention. Preferred variants are apparent from the claims, from the description, and from the working examples.

In accordance with the invention the barrier layers of the film are subdivided. Surprisingly it has been established that the subdivision of the barrier layers significantly improves the mechanical properties of the film and at the same time preserves a high oxygen impermeability without increasing the thickness of the film.

In one particularly favorable variant of the invention, the tear resistance as a result of the subdivision increases by a factor of 1.5, preferably by a factor of 2, more particularly by a factor of 2.5. This is greatly important particularly with silaging tubes. As a result, silaging tubes are provided which, with a high oxygen impermeability and a flexible behavior, at the same time exhibit high tear resistance, so preventing unwanted bursting or tearing and at the same time necessitating only a relatively low thickness of the multilayer film, which means that the silage tube of the invention is relatively light.

In order to fulfil their function, the agricultural films of the invention must have a specific oxygen impermeability. Only this ensures a corresponding fermentation process in the course of ensilage in the silage tube, for example, and an impermeability to chemicals in the case of disinfection films. For this purpose, the barrier arrangement must have a specific total thickness in order to reduce the gas permeability. When the method of the invention is employed, the subdivision of the oxygen barrier arrangement largely retains the gas impermeability and at the same time significantly increases the tear resistance of the film. The individual sublayers each have individual thicknesses which in their entirety add up again to make the total thickness of the barrier arrangement. After subdivision of the oxygen barrier arrangement into at least two layers, the film, with the same total thickness, preferably has an oxygen permeability which is approximately within the range as was present before the subdivision, with the deviation being not more than 20%, preferably not more than 10%, more particularly not more than 5%.

Preferably the oxygen permeability of the film of the invention according to DIN 53380-3 at 23° C. and 50% relative humidity is at most

$$500 \frac{{cm}^{3}}{{m}^{2} \cdot d \cdot bar} ,$$

preferably at most

$$250 \frac{{cm}^{3}}{{m}^{2} \cdot d \cdot bar} ,$$

more particularly at most

$$100 \frac{{cm}^{3}}{{m}^{2} \cdot d \cdot bar} .$$

By employing the method of the invention it is possible for the tear resistance of multilayer films which have one or more oxygen barrier layers having a certain total thickness, in order to ensure a specific oxygen impermeability, to be increased efficiently through subdivision of these oxygen barrier layers. This subdivision of the oxygen barrier layers into a plurality of sublayers retains the oxygen impermeability at a high level and at the same time significantly raises the tear resistance.

Where the film already has a plurality of oxygen barrier layers, it is possible, by using the method for increasing the tear resistance, to subdivide each oxygen barrier layer into sublayers in order to increase the tear resistance.

The use of the method of the invention provides a film which, with a relatively low thickness, has a high oxygen impermeability and at the same time a high tear resistance; it proves favorable if the DIN 53128 Elmendorf tear resistance of the film in longitudinal direction (MC) and/or transverse direction (TD) is more than

$$10 \frac{g}{μm} ,$$

preferably more than

$$20 \frac{g}{μm} ,$$

more particularly more than

$$30 \frac{g}{μm} .$$

In one particularly favorable variant of the invention, the tear resistance of the film in longitudinal direction (MC) and/or transverse direction (TD) is more than

$$40 \frac{g}{µm} .$$

In one particularly favorable embodiment of the invention, the barrier arrangement is subdivided into layers having individual thicknesses which are situated in relation to one another between a ratio of 1:1 up to a ratio at 1:10, preferably between a 1:1 ratio up to a ratio at 1:5, more particularly between a ratio of 1:1 up to a 1:3 ratio.

It proves particularly advantageous if, after the subdivision of the barrier arrangement, the film has similar individual thicknesses of the subdivided layers, the deviation being not more than 20%, preferably not more than 10%, more particularly not more than 5%.

In the case of one particularly advantageous variant of the invention, the barrier arrangement is subdivided into layers of approximately equal thickness, with the individual thicknesses of the layers each adding again to make the total thickness of the barrier arrangement.

The barrier arrangement preferably is formed to an extent of at least 50 wt % of materials from the group encompassing polyamide, copolyamide, polyester, copolyester, polyethylene-vinyl alcohol, polyvinyl alcohol, and/or mixtures thereof. It proves advantageous in this case if the barrier arrangement, besides these materials, contains at most 20 wt % of further polymeric constituents, preferably 10 wt % of further polymeric constituents, more particularly no further polymeric constituents.

In one particularly advantageous variant, the barrier arrangement is formed of polyamides and/or copolyamides, preferably mixtures of PA6, PA6/66, PA66, PA6/6T and/or other aliphatic, aromatic or semiaromatic polyamides or copolyamides. The barrier arrangement comprises preferably at least 50%, more preferably at least 70%, and more preferably still at least 90% of one or more materials from the group encompassing polyamide and/or copolyamide, preferably PA6, PA66, PA6/66, PA6I6T and/or other aliphatic, aromatic or semiaromatic polyamides or copolyamides.

In one particularly favorable variant of the invention, the film has outer layers of a polyolefin. In this case, one of these outer layers faces the silage side or the soil side; the other outer layer preferably faces the atmosphere.

It proves favorable in this case if at least one polyolefin layer of the film is the product of a polymerization process which uses a metallocene catalyst. In one variant of the invention, the barrier arrangement consists of a metallocene-PE, preferably a metallocene-PE of low density, more particularly a metallocene-LLDPE.

In one variant of the invention, there are tie layers between the individual layers of the film. The multilayer film is preferably a coextruded film. The tie layer is extruded between each of the individual layers. The tie layers may also comprise metallocene-catalyzed polyolefins, an example being a metallocene-LLDPE optionally with additives. A maleic anhydride is employed preferably as a tie layer.

In the case of one particularly favorable implementation of the invention, the film is a relatively thin film which in spite of the low thickness has sufficient tear resistance and at the same time high oxygen barrier properties. In this case it proves advantageous if the thickness of the film is less than 200 μm, preferably less than 180 μm, more particularly less than 160 μm, and/or the thickness of the film is more than 10 μm, preferably more than 15 μm, more particularly more than 20 μm.

### DETAILED DESCRIPTION

Further features and advantages of the invention are apparent from the description of working examples.

### Example 1

Table 1 shows two multilayer films each with a thickness of 70 μm; the right-hand column lists the mechanical properties of the film before the subdivision, and the left-hand column the mechanical properties of the film after subdivision of the barrier arrangement.

| | 70 μm | 70 μm |
|---|---|---|
| | 2 × 5 μm PA | 1 × 10 μm PA |
| Dart drop (g) | 1780 | 1760 |
| Tensile strength (MPa) MD | 49.7 | 45.0 |
| TD | 47.4 | 39.7 |
| Elongation at break (%) MD | 535 | 520 |
| TD | 555 | 525 |
| $Tear resistance \frac{g}{µm} M D$ | 39.7 | 12.6 |
| TD | 51.2 | 14.8 |

The barrier arrangement of the film comprises a PA layer having a total thickness of 10 μm. The DIN 53128 Elmendorf tear resistance in machine direction (MD) is

$$12.6 \frac{g}{µm} .$$

The DIN 53128 Elmendorf tear resistance in transverse direction, TD, is

$$14.8 \frac{g}{µm} .$$

By using the method of the invention, the polyamide barrier arrangement is subdivided into two layers each with an individual thickness of 5 μm. The sum of the individual thicknesses of the barrier layers add up again to give the total density of the barrier arrangement. Surprisingly it has been found that the subdivision of the barrier arrangement significantly raises the tear resistance of the film.

In working example 1, the DIN 53128 Elmendorf tear resistance in machine direction (MD) increases from

$$12.6 \frac{g}{µm}$$

(right-hand column) to

$$39.7 \frac{g}{µm}$$

(left-hand column). Accordingly, through use of the method of the invention, the tear resistance in machine direction (MD) rises by a factor of 3.15.

The DIN 53128 Elmendorf tear resistance in transverse direction (TD) increases from

$$14.8 \frac{g}{µm} to 51.2 \frac{g}{µm}$$

by a factor of 3.46.

All tear resistances specified are DIN 53128 Elmendorf values.

Prior to the subdivision of the barrier arrangement in accordance with example 1 (right-hand column), the construction of the individual layers in the film is as follows:

12.7 vol % metallocene-LLDPE with additives, especially antiblock additives

13 vol % metallocene-LLDPE

17 vol % tie layer—metallocene LLDPE

14.3 vol % barrier arrangement, copolyamide PA6/6.6

17 vol % tie layer—metallocene LLDPE

13 vol % metallocene-LLDPE

13 vol % metallocene-LLDPE with additives, especially antiblock additives

After the subdivision of the barrier arrangement in accordance with example 1 (left-hand column), the construction of the individual layers in the film is as follows:

17 vol % metallocene-LLDPE with additives, especially antiblock additives

17 vol % tie layer—metallocene LLDPE

7.15 vol % barrier arrangement, copolyamide PA6/6.6

17.7 vol % tie layer—metallocene LLDPE

7.15 vol % barrier arrangement, copolyamide 6/6.6

17 vol % tie layer—metallocene LLDPE

17 vol % metallocene-LLDPE with additives, especially antiblock additives

### Example 2

Table 2 shows a multilayer film with a thickness of 85 μm; the right-hand column lists the mechanical properties of the film before the subdivision, and the left-hand column the mechanical properties of the subdivision of the film after subdivision.

| | 85 μm | 85 μm |
|---|---|---|
| | 2 × 8.5 μm PA | 1 × 17 μm PA |
| Dart drop (g) | >1690 | >1690 |
| (g/μm) | >20.4 | >20.6 |
| Tensile strength (MPa) MD | 45.2 | 45.5 |
| TD | 45.9 | 43.8 |
| Elongation at break (%) MD | 480 | 470 |
| TD | 460 | 450 |
| $Tear resistance \frac{g}{µm} M D$ | 53.2 | 6.3 |
| TD | 56.1 | 8.1 |

The barrier arrangement of the film comprises a PA layer of 17 μm (right-hand column). The tear resistance in machine direction (MD) is

$$6.3 \frac{g}{µm} .$$

By using the method of the invention, the polyamide barrier arrangement is subdivided into two layers each with an individual thickness of 8.5 μm. The sum of the individual thicknesses of the barrier layers add up again to give the total thickness of the barrier arrangement. Here as well, it was surprisingly found that the subdivision of the barrier arrangement significantly raises the tear resistance of the film.

In working example 2, the tear resistance in machine direction (MD) increases from

$$6.3 \frac{g}{µm}$$

(right-hand column) to

$$53.2 \frac{g}{µm}$$

(left-hand column). Accordingly, through use of the method of the invention, the tear resistance in machine direction (MD) rises by a factor of 8.44. The tear resistance in transverse direction (TD) increases from

$$8.1 \frac{g}{µm} to 56.1 \frac{g}{µm}$$

by a factor of 6.93.

Prior to the subdivision of the barrier arrangement (right-hand column), the construction of the individual layers in the film is as follows:

12 vol % metallocene-LLDPE with additives

16 vol % tie layer—copolymer EBA

20 vol % barrier arrangement, copolyamide 6/6.6

14 vol % tie layer—LLDPE

10 vol % copolymer EBA

16 vol % copolymer EBA

12 vol % metallocene-LLDPE with additives

After the subdivision of the barrier arrangement in accordance with example 2 (left-hand column), the construction of the individual layers in the film is as follows:

12 vol % metallocene-LLDPE with additives

21 vol % tie layer—copolymer EBA

10 vol % barrier arrangement, copolyamide PA6/6.6

14 vol % tie layer—metallocene LLDPE

10 vol % barrier arrangement, copolyamide 6/6.6

21 vol % tie layer—copolymer EBA

12 vol % metallocene-LLDPE with additives

### Example 3

Table 3 shows multilayer films having a thickness of 115 μm. The left-hand column lists the mechanical properties of the film before the subdivision. The middle and right-hand columns list the mechanical properties of the films after subdivision.

| | | | 115 μm |
|---|---|---|---|
| | 115 μm | 115 μm | 4 μm PA & |
| | 1 × 14 μm PA | 2 × 7 μm PA | 10 μm PA |
| Dart drop (g) | 1385 | >1670 | >1670 |
| (g/μm) | 11.3 | >14.5 | >14.9 |
| Tensile strength (MPa) MD | 44.6 | 47.6 | 42.7 |
| TD | 39.6 | 36.6 | 43.9 |
| Elongation at break (%) MD | 520 | 545 | 525 |
| TD | 450 | 480 | 520 |
| $Tear resistance \frac{g}{µm} M D$ | 13.2 | >44.4 | 15.1 |
| TD | 19.2 | >47.1 | 23.6 |

The barrier arrangement of the film comprises a PA layer having a total thickness of 14 μm. Prior to the subdivision of the barrier arrangement, the tear resistance in machine direction (MD) is

$$13.2 \frac{g}{µm} .$$

The tear resistance in transverse direction, TD, is

$$19.2 \frac{g}{µm} .$$

Through use of the method of the invention, the barrier arrangement is subdivided into two layers in each case.

In the middle column, the barrier arrangement is subdivided into two layers of equal thickness, having an individual thickness of 7 μm in each case. In this case the tear resistance increases from

$$13.2 \frac{g}{µm}$$

to more than

$$44.4 \frac{g}{µm}$$

in machine direction, by a factor of 3.36, and in the transverse direction, TD, from

$$19.2 \frac{g}{µm}$$

to more than

$$47.1 \frac{g}{μm}$$

by a factor of 2.45.

In accordance with the right-hand column, the barrier arrangement is subdivided into a layer having a thickness of 4 μm and a layer having a thickness of 10 μm. The barrier layer is therefore subdivided in a ratio of 1:2.5. The tear resistance increases in machine direction from

$$13.2 \frac{g}{μm} to 15.1 \frac{g}{μm}$$

by a factor of 1.14 and in transverse direction from 19.2 μm to 23.26 μm, by a factor of 1.23.

Prior to the subdivision of the barrier arrangement (left-hand column), the construction of the individual layers of the film is as follows:

24 vol % LLDPE bimodal with additives

10 vol % LLDPE bimodal

10 vol % tie layer—LLDPE bimodal

12 vol % barrier arrangement, copolyamide 6/6.6

10 vol % tie layer—LLDPE bimodal

10 vol % LLDPE bimodal

24 vol % LLDPE bimodal with additives

After subdivision of the barrier arrangement into two layers of equal thickness, each of 7 μm, the construction of the individual layers of the film is as follows:

24 vol % LLDPE bimodal with additives

13 vol % tie layer—LLDPE bimodal

6 vol % barrier arrangement, copolyamide 6/6.6

14 vol % tie layer—LLDPE bimodal

6 vol % barrier arrangement, copolyamide PA 6/6.6

13 vol % tie layer—LLDPE bimodal

24 vol % LLDPE bimodal with additives

After the subdivision according to example 3 (right-hand column) into layers of different thickness, with in each case one layer having a thickness of 4 μm and a further layer of the barrier arrangement having a thickness of 10 μm, the construction of the individual layers in the film is as follows:

24 vol % LLDPE bimodal with additives

13 vol % tie layer—LLDPE bimodal

3 vol % barrier arrangement, copolyamide 6/6.6

14 vol % tie layer—LLDPE bimodal

9 vol % barrier arrangement, copolyamide PA 6/6.6

13 vol % tie layer—LLDPE bimodal

24 vol % LLDPE bimodal with additives

### Example 4

Through use of the method of the invention, an apparatus provided is a silage tube of the invention which comprises a multilayer film which has at least one barrier arrangement having a total thickness for reducing a gas permeability, wherein the barrier arrangement is subdivided into at least two layers, the silage tube having a 53128 Elmendorf tear resistance in machine direction (MD) and/or transverse direction, TD, of more than

$$10 \frac{g}{μm} ,$$

preferably more than

$$20 \frac{g}{μm} ,$$

more particularly more than

$$30 \frac{g}{μm} ,$$

the film having an oxygen permeability of at most

$$500 \frac{{cm}^{3}}{{m}^{2} \cdot d \cdot bar} ,$$

preferably

$$250 \frac{{cm}^{3}}{{m}^{2} \cdot d \cdot bar} ,$$

more particularly

$$100 \frac{{cm}^{3}}{{m}^{2} \cdot d \cdot bar} ,$$

the oxygen permeability being determined according to DIN 53380-3 at 23° C. and 50% relative humidity, and the thickness of the film being less than 150 μm, preferably less than 125 μm, more particularly less than 100 μm.

### Example 5

In the case of another variant, through use of the method of the invention, an apparatus provided is a disinfection film of the invention which has at least one barrier arrangement having a total thickness for reducing a gas permeability, wherein in accordance with the invention the barrier arrangement is subdivided, for increasing the tear resistance, into at least two layers, so that the DIN 53128 Elmendorf tear resistance of the disinfection film in machine direction, MD, and/or transverse direction, TD, is more than

$$10 \frac{g}{μm} ,$$

preferably more than

$$20 \frac{g}{μm} ,$$

more particularly more than

$$30 \frac{g}{μm} ,$$

the film having an oxygen permeability of at most

$$500 \frac{{cm}^{3}}{{m}^{2} \cdot d \cdot bar} ,$$

preferably

$$250 \frac{{cm}^{3}}{{m}^{2} \cdot d \cdot bar} ,$$

more particularly

$$100 \frac{{cm}^{3}}{{m}^{2} \cdot d \cdot bar} ,$$

the oxygen permeability being determined according to DIN 53380-3 at 23° C. and 50% relative humidity, and the thickness of the film being less than 150 μm, preferably less than 125 μm, more particularly less than 100 μm.

1. A method for increasing a tear resistance of a multilayer film, having a barrier arrangement which has a total thickness for reducing a gas permeability, the method comprising: sub-dividing the barrier arrangement into at least two layers in the multilayer film.

2. The method as claimed in claim 1, further comprising: increasing the tear resistance as a result of the subdivision by a factor of 1.5 or more.

3. The method as claimed in claim 1, further comprising after the subdivision of the barrier arrangement, providing the film with a same total thickness, and providing the film with an oxygen permeability similar to that before the subdivision of the barrier arrangement, the oxygen permeability being determined according to DIN 53380-3 at 23° C. and 50% relative humidity, and the oxygen permeability after the subdivision deviates from the oxygen permeability before the subdivision by not more than 30%.

4. The method as claimed in claim 1, further comprising: sub-dividing the barrier arrangement into layers having individual thicknesses which are situated in relation to one another between a ratio of 1:1 up to a ratio of 1:10.

5. The method as claimed in claim 1, further comprising: providing all the layers of the barrier arrangement with similar individual thicknesses, the deviation being not more than 20%.

6. The method as claimed in claim 1, further comprising: forming the barrier arrangement of at least 50 wt % of materials from the group consisting of at least one of:
a polyamide,
a copolyamide,
a polyester,
a copolyester,
polyethylene-vinyl alcohol,
polyvinyl alcohol or
mixtures thereof.

7. The method as claimed in claim 1, further comprising: forming the film with outer layers of a polyolefin.

8. The method as claimed in claim 1, further comprising: forming the barrier arrangement from at least one of the materials in the group including
a polyamide,
a copolyamide,
a polyester,
a copolyester,
polyethylene-vinyl alcohol,
polyvinyl alcohol,
or mixtures thereof,
and at most 20 wt % of further polymeric constituents.

9. The method as claimed in claim 1, further comprising: forming the barrier arrangement of at least one of a polyamide or a copolyamide.

10. The method as claimed in claim 1, further comprising: forming the film with a thickness of less than 200 μm and more than 10 μm.

11. An apparatus for agricultural use, comprising a multilayer film including a barrier arrangement having a total thickness to reduce a gas permeability, and the barrier arrangement is subdivided into at least two layers, a DIN 53128 Elmendorf tear resistance of the film in at least one of a machine direction (MD) or transverse direction (TD) being more than
$$10 \frac{g}{μm} ,$$

12. The apparatus as claimed in claim 11, wherein the film has an oxygen permeability of at most 500 cm²/m²·d·bar determined according to DIN 53380-3 at 23° C. and 50% relative humidity.

13. The apparatus as claimed in claim 11 individual thicknesses of the at least two layers relative to one another is between a ratio of 1:1 up to a ratio of 1:10.

14. The apparatus as claimed in claim 11, wherein the layers of the barrier arrangement all have similar individual thicknesses, with a deviation being preferably not more than 20% between the layers.

15. The apparatus as claimed in claim 11, wherein the barrier arrangement is formed of at least 50 wt % of materials from the group including at least one of:
a polyamide,
a copolyamide,
a polyester,
a copolyester,
polyethylene-vinyl alcohol,
polyvinyl alcohol,
or mixtures thereof.

16. The apparatus as claimed in claim 11, wherein the film further comprises outer layers of a polyolefin.

17. The apparatus as claimed in claim 11, wherein the barrier arrangement is formed from at least one of the materials in the group including at least one of
a polyamide,
a copolyamide,
a polyester,
a copolyester,
polyvinyl,
polyethylene-vinyl alcohol,
polyvinyl alcohol,
or mixtures thereof,
and at most 20 wt % of further polymeric constituents.

18. The apparatus as claimed in claim 11, wherein the barrier arrangement is comprised of at least one of a polyamide or a copolyamide.

19. The apparatus as claimed in claim 11, wherein a thickness of the film is less than 200 μm and more than 10 μm.

20. The apparatus of claim 16, wherein the polyolefin is a product of a polymerization process which uses a metallocene catalyst.
